(19) United States
(12) Patent Application Publication
(10) Pub. No.: US 2024/0032502 A1
(43) Pub. Date: Feb. 1, 2024

(54) ANIMAL FEEDING BUCKET

(71) Applicants: Leslie P. Duke, Lindale, GA (US); Savannah G. Marion, Lindale, GA (US)

(72) Inventors: Leslie P. Duke, Lindale, GA (US); Savannah G. Marion, Lindale, GA (US)

(21) Appl. No.: 18/379,417

(22) Filed: Oct. 12, 2023

Related U.S. Application Data
(63) Continuation-in-part of application No. 17/236,321, filed on Apr. 21, 2021.

(51) Int. Cl. A01K 5/01

(52) U.S. Cl. CPC A01K 5/0107

(57) ABSTRACT

An animal feeding bucket an animal feeding bucket includes a container, a locking system, and a base plate. The container has a top edge, a bottom, and sidewalls. The base plate includes spike holes therethrough. The base plate also includes mounting spikes extending through the spike holes. The locking system includes a first locking member coupled to the base plate and a second locking member coupled to the container bottom. The first locking member has four inverted L-shaped locking flanges having vertical walls and an inwardly extending top walls. The locking flanges define lock recesses. The second locking member has four radially and outwardly extending locking tabs. Each locking tab is configured to be received within a lock recess of one locking flange to interlock the locking tab with the locking flange.

### CROSS REFERENCE TO RELATED APPLICATIONS

This is a continuation-in-part of U.S. patent application Ser. No. 17/236,321 filed on Apr. 21, 2021 and entitled Animal Feeding Bucket.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The present inventive concept relates to the field of an animal feeders. More particularly, the invention relates to a portable animal feeding bucket.

### Technology in the Field of the Invention

The owner of large animals, such as horses, cattle, goats or sheep, must feed their animals on a daily basis. These animals typically eat gain, or the like, that is delivered to the feeding site in buckets. These buckets of feed, or water, may vary in size and shape. The bucket may be simply placed upon the ground so that the animal may feed from the open top of the bucket.

A larger problem related to the use of feeding buckets is that the animal or animals may tip over the bucket during the feeding process, the chances of which increase when several animals are eating from the same feeding bucket. Also, the animal may accidently step on a bucket, causing it to tip over and spread the feed or water upon the ground.

Another problem with feeding buckets is that if they are made too sturdy a horse or other large animal may injure itself should it accidentally step on the bucket, thereby causing it to fall or strike the animal's legs.

Accordingly, a need exists for an animal feeder that may maintain a bucket of feed or water upright while allowing unencumbered access for the animal. It is to the provision of such therefore that the present invention is primarily directed.

### BRIEF SUMMARY OF THE INVENTION

An animal feeding bucket comprises a container for holding a volume of animal feed or water, a base plate, and a lock releasably securing the container to the base plate.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an animal feeding bucket embodying principles of the invention in a preferred form.

FIG. 2 is an exploded, perspective view of the animal feeding bucket of FIG. 1.

FIG. 3 is a partial cross-sectional view of a portion of an animal feeding bucket embodying principles of the invention in another preferred form.

FIG. 4 is a partial cross-sectional view of a portion of an animal feeding bucket embodying principles of the invention in another preferred form.

FIG. 5 is a cross-sectional view of a portion of an animal feeding bucket embodying principles of the invention in another preferred form.

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

With reference next to the drawings, there is a shown an animal feeding bucket 10 in a preferred form of the present invention. The animal feeding bucket 10 includes a main bucket, pale, or container 12, a coupler or locking system 14, and a base plate or platform 16. The bucket is configured to hold large quantities of water or food with enough capacity for feeding a large animal, as opposed to small cups, bowls or the like intended to liquids or food for human consumption.

The container 12 has a top edge 18, a bottom or floor 20, and sidewalls 22 extending between the bottom 20 and top edge 18. A pivoting carrying handle 24 may be mounted to the sidewalls 22 adjacent the top edge 18. The container 12 is specifically configured to contain animal feed, water, or other substances, herein referred collectively as animal feed F.

The base plate 16 is generally circular with a diameter equal to or greater than the diameter of the container 12 at the top edge 18. The base plate 16 includes a plurality of spike holes 28 extending therethrough from a top surface 30. The base plate 16 also includes a plurality of mounting spikes 32. Each mounting spike has an elongated shaft 34 and a head 36 at one end of the shaft 34. The elongated shaft 34 is configured to pass through spike hole 28, while the head 36 is configured to be larger than the spike hole 28 so that it does not pass through the spike hole 28, i.e., the head 36 abuts the top surface of the base plate 16.

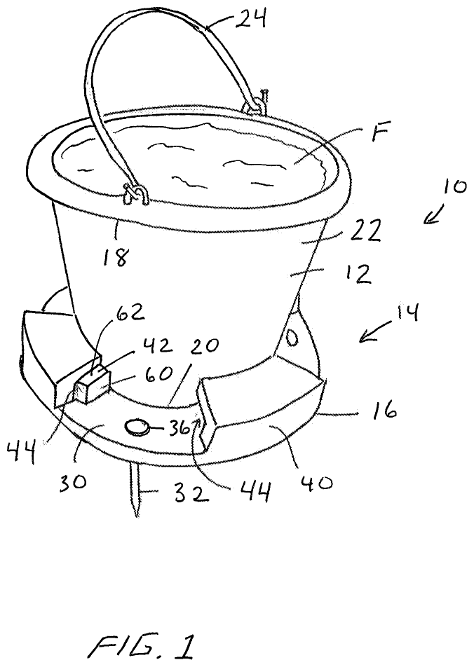

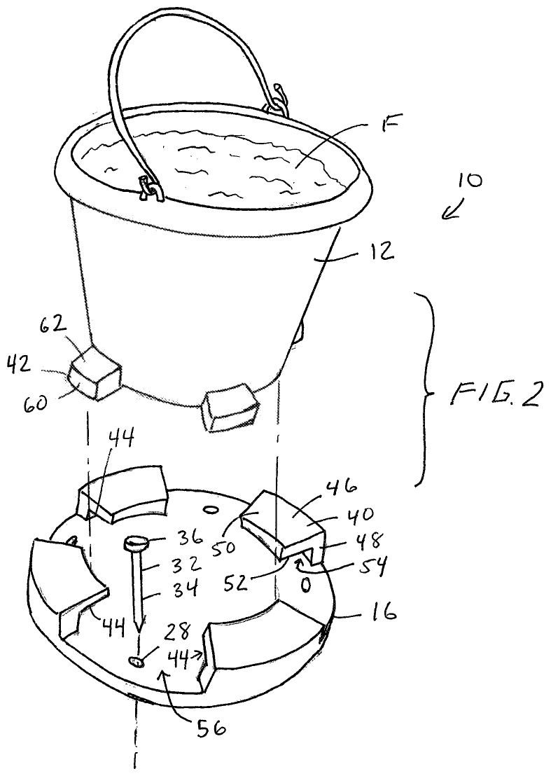

The locking system 14 includes a female or first locking member 40 coupled to the top surface 30 of the base plate 16 and a second locking member 42 coupled to the bottom 20 of the container 12. The first locking member 40 is configured to mate or mesh with the male or second locking member 42 for movement between a locked position, shown in FIG. 1, and an unlocked position, shown in FIG. 2. It should be noted that the female locking member 40 has two oppositely disposed open ends 44 which allow debris residing within the space between the first locking member 40 and the base plate 16 to be removed by either manually pushing the debris out of one open end 44 with a person's finger or by pushing debris out by rotating the second locking member 42 through the space. As such, dirt or mud from the animal's environment that becomes stuck to the mounting plate or tabs won't interfere or cause binding with the locking of the container 12 as it is easily and quickly removed.

The first locking member 40 has four inverted L-shaped locking catches or flanges 46. Each locking flange 46 has an upright or vertical wall 48 and an inwardly extending top wall 50. The bottom surface 52 of each top wall 50 is set at a declining angle or slope in a clockwise direction. The locking flanges 46 in combination with the base plate 16 define lock recesses 54 below the top walls 50. An entrance space 56 is positioned between each adjacent pair of locking flanges 46.

The second locking member 42 has four radially and outwardly extending locking ears, flanges, or tabs 60. Each locking tab 60 is configured to be received within entrance space 56 and be rotated into the lock recess 54 of one locking flange 46. The top surface 62 of the locking tab 60 is set at a declining angle or slope in a clockwise direction. The slope of the top surface 62 is approximately equal to the slope of the bottom surface 58 of the top wall 50, so that the locking tabs 60 and locking flanges 46 act as a cam and cam follower of a camming system that tightens the locking flange 46 of the first locking member 40 against the locking tabs 60 of the second locking member 42 through clockwise rotation of the second locking member 42.

All components of the animal feeding bucket 10 may be made of any conventional material used to form such containers, such as metal, plastic, wood, or the like.

In use, the base plate 16 may be set upon the ground at the preferred location of feeding and the mounting spikes 32 are slid though the spike holes 28 and forced into the underlying ground until the mounting spike heads 36 abut the base plate 16. Thus, the spikes firmly mount the base plate 16 to the ground.

An amount, volume, or mass of animal feed, water, or other material F may be placed within the container 12. The container 12 is then securely locked onto the base plate 16 utilizing the locking system 14. To do so, the container 12 is lowered until the locking tabs 60 are positioned within the entrance spaces 56 between adjacent locking flanges 46. The container 12 is then rotated in the clockwise direction so that the locking tabs 60 rotatably move into the lock recesses 54 below the locking flanges 46. The container 12 is rotated until the cooperation between the sloping bottom surface 52 of the locking flanges top wall and the top surface 62 of the locking tabs 60 snugly interlocks the first locking member with the second locking member 42, i.e., the first locking member 40 is locked to the second locking member 42.

With the container 12 locked to the base plate 16, the container 12 resists being tipped over or moved through contact with a feeding animal by both the expanded diameter of the base plate 16 compared to the bottom of the container 12. Furthermore, the container 12 is resistant to tipping through the anchoring of the animal feeding bucket 10 through the mounting spikes 32 passing through the base plate 16 and into the underlying ground.

The second locking member 42 may be designed to break off or breakaway from the remaining container 12 should an animal strike or step upon the container with a striking force that may cause harm to the animal by causing it to trip, fall or become entangled with the container 12. The striking force may be considered a force that is not a rotational movement between the container 12 and the base plate 16 that is sufficiently large so as to cause the unwanted separation between the container and the base plate 16. This break away feature may be achieved by scoring the second locking member 42, thinning a portion of the second locking member 42, or the like. Similarly, either the first or second locking members may be held in position through magnets 66, as shown in FIG. 5. With this construction, the breakaway locking members may be put back in place through magnetic attraction after being dislodged by an animal forcibly contacting the animal feeding bucket.

As shown in FIG. 3, the peripheral edge or outer end of the second locking mechanism 42 may include rounded ends 43 (vertically rounded in cross-section) while the first locking mechanism 40 includes a corresponding rounded interior groove 47 (vertically rounded in cross-section) or interior end wall 51. Here the top ledge 49 of the first locking mechanism is also shortened so that if enough pressure is applied to the container 12, the second locking mechanisms 42 will pop out of the groove 47 of the first locking mechanisms to quickly release the container 12 from the plate 16. Once the container is removed, it may be reinserted through the normal twisting action between the first and second locking mechanisms. This quick releasing of the container allow for a breakaway feature of the bucket to prevent harm to the animal should the container 12 receive a striking force from the animal, as previously described.

It should be understood that as an alternative to the removable spikes 32, the base plate 16 may include spikes that are permanently affixed to extend downwardly from the base plate 16.

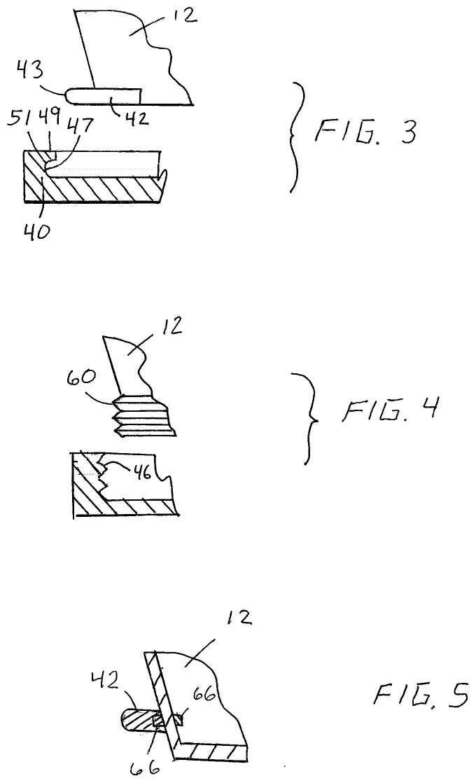

It should be understood that other types of coupling or locking means may be used as an alternative to the cooperating locking tabs 60 and locking flange 46 arrangement shown in the drawings. For example, the locking tabs bay be in the form of helical threads, as shown in FIG. 4. Also, it should be understood that the positioning of the locking tabs 60 and locking flanges may be reversed, so that the locking tabs 60 are positioned on the base plate 16 and the locking flanges 46 are positioned on the container 12.

It should be understood that as an alternative to the spikes 32, the base plate 16 may include other types of fasteners, such as bolts or screws, or other types of fasteners, that may be used to mount the base plate 16 to a stationary object such as a shelf, beam, floor, or bracket.

It will be appreciated that the inventions are susceptible to modification, variation and change without departing from the spirit thereof.

1. An animal feeding bucket comprising:
an open top container for holding a volume of animal feed or water, the container having a bottom;
a base plate having a width larger than the width of said container bottom, and
a coupler releasably securing said container to said base plate, said coupler including a plurality of radially extending first locking members coupled to said open top container and a plurality of second locking members coupled to said base plate configured to mate with said plurality of first locking members, each said first locking member being configured to break away from said open top container should a striking force be applied to the open top container.

2. The animal feeding bucket of claim 1 wherein each said second locking members includes an open entrance and an open exit so that unwanted debris within the second locking members may be forced out of the open exit through passage of the first locking members through said second locking member.

3. The animal feeding bucket of claim 1 further comprising at least one vertically oriented mounting spike releasably coupled to said base plate.

4. The animal feeding bucket of claim 1 wherein each said first locking member has a vertically rounded peripheral edge and each said second locking member has a rounded interior wall configured to mate with said vertically rounded peripheral edge,
whereby the rounded peripheral edge and rounded interior wall provides for a release of the open top container from the base plate.

5. The animal feeding bucket of claim 1 wherein each said first locking member includes at least one first magnetic portion, and wherein said open top container includes at least one second magnetic portion that is magnetically attracted to said first magnetic portion to provide a releasable mounting of said first locking members to said open top container.

6. The animal feeding bucket of claim 1 wherein said plurality of first locking members includes helical threads, and wherein said plurality of second locking members includes helical grooves.

7. An animal feeding bucket comprising:
an animal feed bucket having a plurality of radially extending locking tabs extending from a container bottom, each said locking tab having a vertically rounded peripheral end, and
a base plate having a plurality of radially extending locking flanges, wherein each said locking flange has a lock recess to rotatably receive one said locking tab of said animal feed bucket, said locking recess having a vertically rounded interior end wall to enable said locking tab to be released from said locking flange should a striking force be applied to said animal feeding bucket,
whereby the rounded peripheral edge and rounded interior end wall provides for a release of the animal feed bucket from the base plate.

8. The animal feeding bucket of claim 7 wherein each locking flange includes an open entrance and an open exit so that unwanted debris within the locking flanges may be forced out of the open exit through passage of the locking tabs.

9. The animal feeding bucket of claim 7 further comprising at least one vertically oriented mounting spike releasably coupled to said base plate.

10. The animal feeding bucket of claim 7 wherein said base plate has a planar bottom surface.

11. The animal feeding bucket of claim 7 wherein each said locking tab is configured to break away from said container.

12. The animal feeding bucket of claim 7 wherein each said locking tab includes a first magnetic portion and wherein said container includes a second magnetic portion to releasably magnetically mount said locking tab to said container.

13. An animal feeding bucket comprising:
a container for holding a volume of animal feed or water, said container having a bottom;
a base plate having a width larger than the width of the container bottom, and
a coupler coupling said container to said base plate, said coupler including first locking members mounted to said container and second locking members mounted to said base plate, each said second locking members having an open entrance and an open exit so that unwanted debris within the second locking members may be forced out of the open exit through passage of the first locking members through said second locking member.

14. The animal feeding bucket of claim 13 wherein said container bottom is circular and wherein said base plate is circular in shape, wherein the diameter of said base plate is larger than the diameter of said container bottom.

15. The animal feeding bucket of claim 13 further comprising at least one vertically oriented spike releasably coupled to said base plate.

16. The animal feeding bucket of claim 13 wherein each said first locking member is configured to break away from said open top container should a striking force be applied to the open top container.

17. The animal feeding bucket of claim 13 wherein each said first locking member has a vertically rounded peripheral edge and each said second locking member has a rounded interior wall configured to mate with said vertically rounded peripheral edge,
whereby the rounded peripheral edge and rounded interior wall provides for a release of the container from the base plate.

18. The animal feeding bucket of claim 13 wherein each said locking tab includes a first magnetic portion and wherein said container includes a second magnetic portion to releasably magnetically mount said locking tab to said container.
